(19) United States
(12) Patent Application Publication
(10) Pub. No.: US 2011/0151204 A1
(43) Pub. Date: Jun. 23, 2011

(54) IDENTIFICATION TAPE

(75) Inventor: FANG-YU LIEN, Taipei (TW)

(73) Assignee: GS TECHNOLOGY CORP., Jalan Cator (BN)

(21) Appl. No.: 12/956,571

(22) Filed: Nov. 30, 2010

(30) Foreign Application Priority Data
Dec. 17, 2009 (TW) 098223642

(51) Int. Cl. B32B 3/10

(52) U.S. Cl. 428/195.1

(57) ABSTRACT

An identification tape is disclosed, which comprises: an implicit identification layer, doped with a plurality of implicit symbols; a color layer, formed on the implicit identification layer; and an explicit identification layer, formed on the color layer while enabling its information sub-layer to be formed on a surface thereof facing toward the color layer. By the formation of the implicit identification layer in the identification tape of the invention, any user in a dim-light environment will be able to identify whether the identification tape is genuine, or whether or not the identification tape had been tampered using the implicit symbols contained in the implicit identification layer. Thereby, the identification tape of the invention is equipped with good anti-counterfeiting and anti-tampering abilities.

### FIELD OF THE INVENTION

The present invention relates to an identification tape, and more particularly, to an identification tape designed with anti-counterfeiting and anti-tampering abilities.

### BACKGROUND OF THE INVENTION

With rapid advance in technology, the security of information transmission is becoming more and more demanding and important. Consequently, with the increasing demand in package safety by consumers, there are already many sealing tapes with anti-counterfeit and anti-tampering abilities being provided, such as dust tape for packaging and sealing document bags containing important document files or courier bags, court seals, and so on. All those sealing tapes with anti-counterfeit and anti-tampering abilities are designed to seal or package an object for preventing the same from being dismantled or tampered carelessly or even intentionally.

One such conventional anti-counterfeit tape 10 is shown in FIG. 5, which comprises: a substrate 11, made of a plastic thin film; a label layer 12, adhering to a back side of the substrate 11 by an adhesive material for printing detach symbols on the back of the substrate; a color layer 13, formed by the coating of color inks onto the label layer 12 as well as the portion of the substrate 11 where is no covered by the label layer 12; an protective layer 14, being a transparent or semi-opaque thin film adhered on the color layer 13; and an adhesive layer 15, formed by the coating of an adhesive on the protective layer 14 so as to be used for adhering the anti-counterfeit taped 10 on an object 16 to be sealed or packaged.

Conventionally, a tampered anti-counterfeit tape can be distinguished from an anti-counterfeit tape that is not tampered by their color difference. The can be a straight forward method for identifying whether a package is tampered, but it is short in that: the condition of the anti-counterfeit tape with respect to its minute color difference may not be clearly identified under a dim-light environment, such as in a warehouse where the illumination is low. Moreover, since the identifying of whether a package is tampered is determined only according to the color change in the identification tape and there is no additional anti-counterfeiting means formed on the identification tape, such security mechanism can be easily bypassed as the identification tape can be forged easily by those interested parties. Thus, when in a dim-light environment, it is possible to have a tampered package whose identification tape is adhered to the package again after being detached that is not being notice and identified.

Therefore, it is in need of an improved identification tape that is designed with anti-counterfeiting/anti-tampering abilities and is able to function satisfactorily without being affected by ambient lighting variation.

### SUMMARY OF THE INVENTION

In view of the disadvantages of prior art, the object of the present invention is to provided an identification tape embedded with two identification data layers, i.e. an explicit identification layer and an implicit identification layer, by that any user is able not only to identify whether a sealed object is being tampered even in a dim-light environment, but also to identify whether the identification tape that is used for sealing the object is genuine. Thereby, the identification tape of the present invention is designed with anti-counterfeiting and anti-tampering abilities.

In an exemplary embodiment, the present invention provides an identification tape, which comprises: an implicit identification layer; a color layer, formed on the implicit identification layer; and an explicit identification layer, formed on the color layer; wherein, the explicit identification layer further has an information sub-layer formed on a surface thereof facing toward the color layer.

In an exemplary embodiment, the implicit identification layer is doped with a plurality of implicit symbols, whereas each implicit symbol can a micro-scaled particle embedded with characters, a nano-scaled particle embedded with characters, a micro-scaled particle embedded with graphs, a nano-scaled particle embedded with graphs, or the combination thereof. In addition, the implicit symbol is a color symbol composed of at least one micro-scaled color unit or at least one nano-scale color unit.

In an exemplary embodiment, the implicit identification layer is formed on an adhesive layer that is constructed with sufficient adhesive for adhering to an object.

In an exemplary embodiment, the implicit identification layer is made of a luminous material, a material doping with a plurality of fluorescent fibers, or a fluorescent material.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a sectional view of an identification tape according to an embodiment of the invention.

FIG. 2A to FIG. 2C are sectional portion enlarged views of identification tape according to different embodiments of the invention.

FIG. 3A and FIG. 3B are a three-dimensional diagram and a sectional diagram showing an identification tape of the present invention when its explicit identification layer is being detached.

FIG. 4 is a sectional view of an identification tape according to another embodiment of the invention.

FIG. 5 is a sectional view of a conventional identification tape.

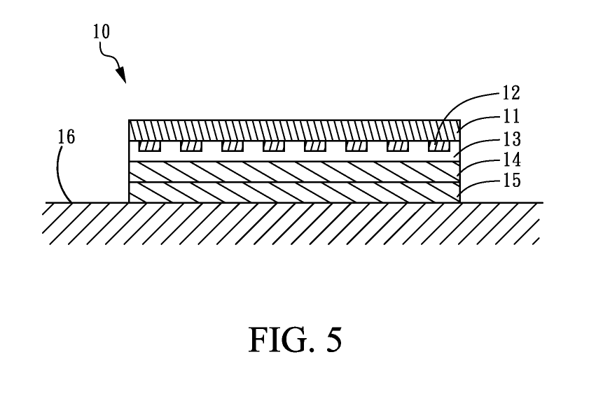

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

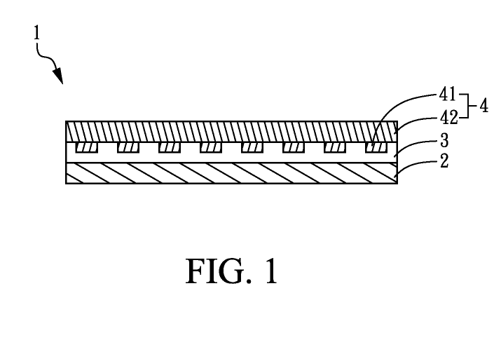

Please refer to FIG. 1, which is a sectional view of an identification tape according to an embodiment of the invention. In this embodiment, the identification tape 1 is composed of an implicit identification layer 2, a color layer 3 and an explicit identification layer 4, in which the color layer 3 is formed on the implicit identification layer 2 while the explicit identification layer 4 is formed on the color layer 3. Moreover, the explicit identification layer 4 is further being configured with a substrate 42 and an information sub-layer 41 in a manner that the information sub-layer 41 is formed on the color layer 3 while the substrate 42 is formed on the information sub-layer 41. It is noted that there can be at least one character set or at least one graph set being embedded in the information sub-layer 41, but is not limited thereby, so that the information sub-layer 41 can be used for enabling a user to identify whether an object that is sealed by the identification tape 1 is tampered or not.

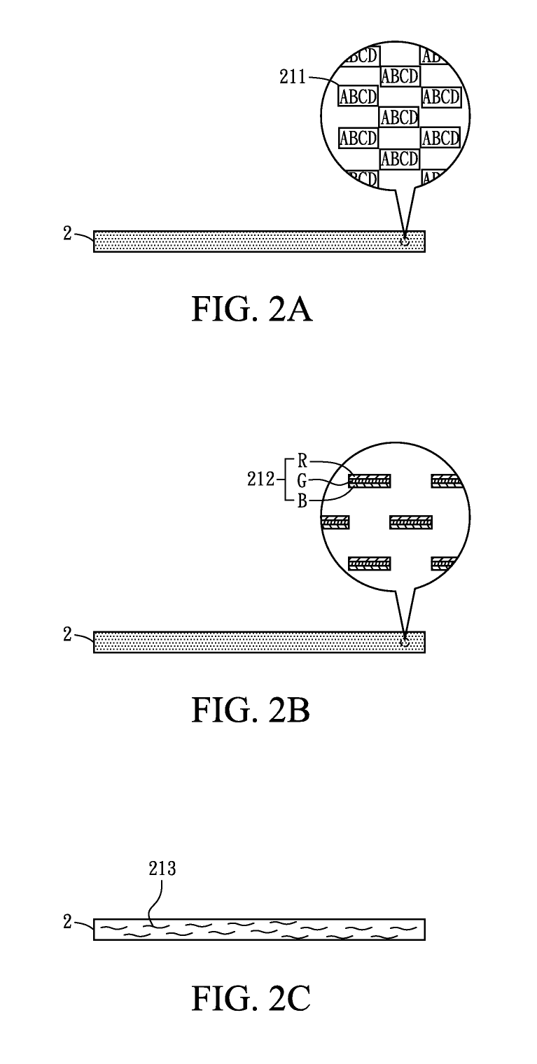

Please refer to FIG. 2A to FIG. 2C, which are sectional portion enlarged views of identification tape according to different embodiments of the invention. As shown in the embodiments of FIG. 2A to FIG. 2C, the implicit identification layer 2 is provided to function as a secondary anti-counterfeiting/anti-tampering guard since it is doped with a plurality of implicit symbols. IN the embodiment shown in FIG. 2A, each of the plural implicit symbols embedded in the implicit identification layer 2 is a particle 211 having characters embedded therein, whereas the character particle 211 can be a micro-scaled particle embedded with characters, or a nano-scaled particle embedded with characters. It is noted that, except for the characters, the particle 211 can be embedded with graphs or the combination of characters and graphs, which is determined according to actual requirement. On the other hand, the implicit symbol can be a color symbol composed of at least one micro-scaled color unit or at least one nano-scale color unit. In the embodiment shown in FIG. 2B, color symbol 212 is a three-layered element composed of a red color unit, a green color unit and a blue color unit, which are symbolized as R, G and B as shown in FIG. 2B. It is noted that the color symbol 212 can be composed of color units of other colors that can be determined as actual required, and moreover, the color symbol 212 is not restricted to be a three-layered element that the amount of layer is not limited thereby. Operationally, the plural implicit symbols embedded inside the implicit identification layer 2 that are shown in FIG. 2A and FIG. 2B are designed to function as the secondary anti-counterfeiting/anti-tampering guard for preventing the counterfeiting or tampering of the identification tape 1. In addition, as any user can easily identify the production source of the identification tape from the information consisted in the implicit identification layer 2, the production and sale of the identification tape can be managed and controlled effectively.

In another embodiment shown in FIG. 2C, the implicit identification layer 2 is doped a plurality of fluorescent fibers 213. In addition to the doping of the fluorescent fibers 213, the implicit identification layer 2 can be made directly of a light-emitting material, such as a luminous material or a fluorescent material, etc. By the doping of fluorescent fibers 213 inside the implicit identification layer 2, or by making the implicit identification layer 2 directly from a luminous material or a fluorescent material, the light emitting from the implicit identification layer 2 can help users to identify whether the identification tape is being tampered under a dim-light environment, that the problem troubling the conventional identification tape as it can not function properly in dim-light environment is resolved.

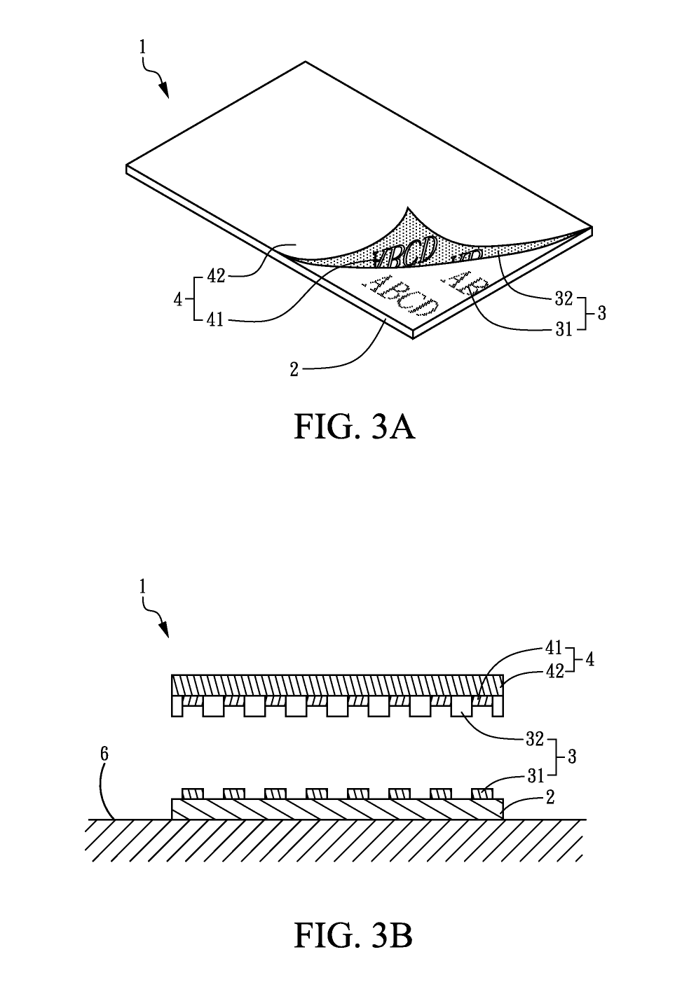

Please refer to FIG. 3A and FIG. 3B, which are a three-dimensional diagram and a sectional diagram showing an identification tape of the present invention when its explicit identification layer is being detached. As shown in FIG. 3A, the identification tape is not a self-adhesive tape so that it should be processed for enabling the same to be able to adhere to the object by an addition adhesive layer or other means. When the explicit identification layer 4 is peeled away from the identification tape 1 by an external force, the portion of the color layer 3 that is corresponding to the information sub-layer 41 will still reside upon the explicit identification layer 2 while the other portion of the color layer 3 that is not corresponding to the information sub-layer 41 will be peeled away from the explicit identification layer 2 along with the peeling of the explicit identification layer 4, and thereby, there will be a layer of color residues 32 sticking to the substrate 42 of the explicit identification layer 4 and correspondingly there will be a layer of color 31 that contained information of the information sub-layer 41 remaining on the explicit identification layer 2. Thus, the anti-counterfeiting and anti-tampering effects are achieved accordingly.

Generally, in some situation that a person who is responsible for tampering the identification tape 1 might try to adhere the peeled explicit identification layer 4 back again for hiding the fact that the identification tape had already been tampered which is especially hard to detect when in a dim-light environment. However, since the explicit identification layer 4 in the identification tape 1 of the invention is either being doped with fluorescent fibers, or is made of fluorescent or luminous materials that it will be exposed for absorbing lighting energy as soon as the explicit identification layer 4 is being peeled away, such exposed fluorescent fibers or fluorescent explicit identification layer 4 will glow in the dark even after the peeled explicit identification layer 4 is being adhered back again, so that when a user detects that there are lights leaking out under the explicit identification layer, she/he can determine that the identification tape 1 had already been tampered. It is noted that the used of the fluorescent material, the luminous materials and the fluorescent fibers can be used in combination with the implicit particles 211 and the color symbol 212 that are shown in FIG. 2A and FIG. 2b.

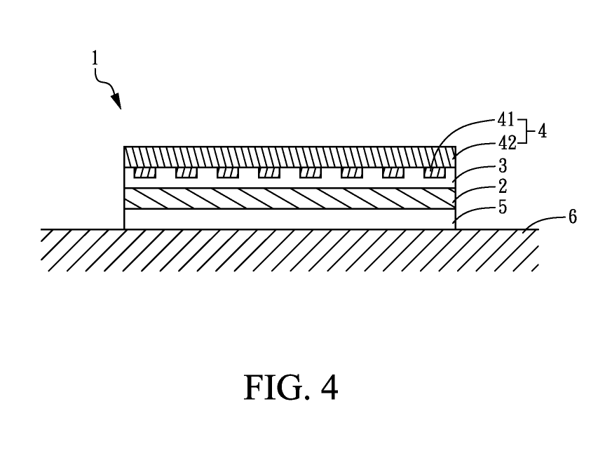

Please refer to FIG. 4, which is a sectional view of an identification tape according to another embodiment of the invention. It is noted that the identification tape shown in the embodiment of FIG. 1 is not a self-adhesive tape. Nevertheless, it is much more convenient if the identification tape is self-adhesive. Thus, the identification tape shown in FIG. 4 is configured with an adhesive layer that is formed on a surface of the implicit identification layer 2 by the use of an adhesive material, by that the identification tape is substantially a duct tape with anti-counterfeiting and anti-tampering abilities that is able to adhere to an object 6 by the adhesive of its adhesive layer 5. It is noted that all the other portions of the identification tape shown in FIG. 4 is constructed the same as those described in the aforesaid embodiments, and thus are not described further herein.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. An identification tape, comprising:
an implicit identification layer;
a color layer, formed on the implicit identification layer; and
an explicit identification layer, formed on the color layer, being configured with an information sub-layer while enabling the same to be formed on a surface thereof facing toward the color layer.

2. The identification tape of claim 1, wherein the information sub-layer is embedded with at least one character set.

3. The identification tape of claim 1, wherein the information sub-layer is embedded with at least one graph set.

4. The identification tape of claim 1, wherein the implicit identification layer is doped with a plurality of implicit symbols.

5. The identification tape of claim 4, wherein each implicit symbol can a micro-scaled particle embedded with characters, a nano-scaled particle embedded with characters, a micro-scaled particle embedded with graphs, a nano-scaled particle embedded with graphs, or the combination thereof.

6. The identification tape of claim 4, wherein the implicit symbol is a color symbol composed of at least one micro-scaled color unit or at least one nano-scale color unit.

7. The identification tape of claim 1, wherein the implicit identification layer is formed on an adhesive layer that is constructed with sufficient adhesive for adhering to an object.

8. The identification tape of claim 1, wherein the implicit identification layer is made of a luminous material.

9. The identification tape of claim 1, wherein the implicit identification layer is made of a material doping with a plurality of fluorescent fibers.

10. The identification tape of claim 1, wherein the implicit identification layer is made of a fluorescent material.

11. The identification tape of claim 1, wherein the explicit identification layer further comprises a substrate that is provided for the information sub-layer to be formed thereon.
